(19) United States
(12) Patent Application Publication
(10) Pub. No.: US 2020/0076320 A1
(43) Pub. Date: Mar. 5, 2020

(54) ELECTRONIC CIRCUIT AND OPERATING METHOD FOR THIS

(71) Applicant: Robert Bosch GmbH, Stuttgart (DE)

(72) Inventors: Dirk Schuster, Kernen (DE); Paul Mehringer, Stuttgart (DE)

(21) Appl. No.: 16/553,277

(22) Filed: Aug. 28, 2019

(30) Foreign Application Priority Data
Sep. 4, 2018 (DE) 10 2018 214 955.0

(51) Int. Cl. H02M 7/217

(52) U.S. Cl. CPC H02M 7/217

(57) ABSTRACT

Electronic circuit with a controllable switch, in particular a semiconductor switch, and a control device for controlling the semiconductor switch, wherein the control device is designed to activate the semiconductor switch depending on the voltage applied to a load path at a first time range of a specifiable, preferably negative, half-wave of a periodic electrical voltage that can be applied to the load path of the semiconductor switch and to enable a deactivation of the semiconductor switch depending on the voltage being applied to the load path initially at a second time range following the first time range.

### BACKGROUND OF THE INVENTION

The disclosure concerns an electronic circuit with a controllable switch, in particular a semiconductor switch and a control device for controlling the controllable switch.

The disclosure also relates to a method for operating such an electronic circuit.

A circuit of the above mentioned type is known from DE 10 2008 042 352 A1. In the case of the known circuit, a switch-on time and/or switch-off time for the controllable switch is calculated on the basis of a characteristic field or a mathematical function. This requires a comparatively great deal of effort to control the switch and a corresponding electrical energy consumption.

### SUMMARY OF THE INVENTION

One object of the present invention is to improve a circuit of the type mentioned above in such a way as to result in a greater practical utility and to reduce or avoid the disadvantages of the state of the art mentioned above.

Preferred embodiments refer to an electronic circuit with a controllable switch, in particular a semiconductor switch, and a control device for controlling the semiconductor switch, wherein the control device is designed to activate the semiconductor switch depending on the voltage that can be applied to a load path at a first time range of a specifiable, preferably negative, half-wave of a periodic electrical voltage that can be applied to the load path of the semiconductor switch and to enable a deactivation of the semiconductor switch depending on the voltage being applied to the load path initially at a second time range following the first time range. This provides a reliable activation of the semiconductor switch at the first time range (for example, when a specifiable voltage value is fallen short of on the load path at the first time range), and simultaneously, by enabling a voltage-dependent deactivation only at the second time range following the first time range, it is avoided that an undesirable deactivation of the semiconductor switch (in particular one that occurs too early in relation to the considered half-wave), for example, due to fluctuations in the voltage on the load path (e.g. due to the activation of the semiconductor switch) can occur already in the first time range.

In other preferred embodiments, the controllable switch is designed as a field effect transistor. In this case, the load path corresponds, for example, to a drain source path of the field effect transistor. In other preferred embodiments, the controllable switch is designed as a bipolar transistor or IGBT (bipolar transistor with an insulated gate electrode). In this case, the load path corresponds, for example, to a collector-emitter path of the bipolar transistor or IGBT.

In other preferred embodiments, it is provided that the control device is designed to determine a first variable that characterizes a duration of the specifiable half-wave, and to determine, depending on the first variable, a first point in time that characterizes a transition from the first time range to the second time range. The first variable can, for example, correspond to half of the period duration of the periodic voltage.

In other preferred embodiments, it is provided that the control device is designed to control an operation of the semiconductor switch depending on the voltage applied to the load path at the second time range.

In other preferred embodiments, it is provided that the control device is designed to determine whether the voltage applied to the load path exceeds a specifiable first threshold.

In other preferred embodiments, it is provided that the control device is designed to deactivate the semiconductor switch at least partially (i.e. to switch to high-impedance) if the voltage applied to the load path exceeds the specifiable first threshold.

In other preferred embodiments, it is provided that the semiconductor switch or at least one semiconductor switch and the control device are arranged on the same semiconductor substrate.

In other preferred embodiments, it is provided that a safety shutdown device is provided, which is designed to deactivate the semiconductor switch if the voltage applied to the load path is positive and exceeds a specifiable second threshold, wherein, in particular, the safety shutdown device is designed to deactivate the semiconductor switch independently of a momentary operating state of the control device. Being particularly preferred, the control system of the semiconductor switch via the safety shutdown device has a higher priority than the control system of the semiconductor switch via the control device. This ensures that, independently of a current operating state or fault state of the control device, a safe deactivation of the semiconductor switch can take place in undesirable operating states (e.g. positive voltage on the load path being greater than the second threshold value).

Further preferred embodiments refer to an active rectifier circuit with at least one circuit in accordance with the embodiments. For example, in preferred embodiments it can be provided that two rectifier elements per phase are connected in series for rectifying a multiphase alternating voltage respectively, wherein, advantageously, a semiconductor switch or a circuit in accordance with the embodiments can be used as rectifier elements respectively. In other preferred embodiments, the rectifying semiconductor switch is located on the load path in the case of negative voltages (in MOSFET, for example, negative drain source voltage), for example, in the conductive state and in the case of positive voltages on the load path (e.g. positive drain source voltage) in the locking state. This is efficiently achievable by means of the control device in accordance with the embodiments. Unwanted fault states can also be advantageously prevented by means of the above-described safety shutdown device.

Other preferred embodiments refer to a method for operating an electronic circuit with a controllable switch, in particular a semiconductor switch, and a control device for controlling the semiconductor switch, wherein the control device activates the semiconductor switch depending on the voltage applied to a load path at a first time range of a specifiable, preferably negative, half-wave of a periodic electrical voltage that can be applied to the load path of the semiconductor switch and enables a deactivation of the semiconductor switch depending on the voltage applied to the load path initially at a second time range following the first time range.

In the case of other preferred embodiments, it is provided that the control device determines a first variable, which characterizes a duration of the specifiable half-wave and determines, depending on the first variable, a first point in time, which characterizes a transition from the first time range to the second time range.

In other preferred embodiments, it is provided that the control device controls an operation of the semiconductor switch depending on the voltage applied to the load path at the second time range.

In other preferred embodiments, it is provided that the control device determines whether the voltage applied to the load path exceeds a specifiable first threshold value.

In other preferred embodiments, it is provided that the control device deactivates the semiconductor switch at least partially if the voltage applied to the load path exceeds the specifiable first threshold.

Other preferred embodiments refer to a use of the method in accordance with the embodiments for operating an active rectifier circuit, wherein the active rectifier circuit comprises, in particular, at least one circuit in accordance with the embodiments.

### BRIEF DESCRIPTION OF THE DRAWINGS

Other features, possible applications and advantages of the invention result from the following description of the exemplary embodiments of the invention, which are shown in the figures of the drawing. Thereby, all described or graphically represented features form the object of the invention on their own or in any combination, independently of their summarization in the claims or their referral, as well as independently of their formulation or representation in the description or in the drawing.

The figures show:

FIG. 1 schematically, a simplified block diagram of an electronic circuit in accordance with an embodiment,

FIG. 2 schematically, a simplified flow chart of a method in accordance with an embodiment,

FIG. 3 schematically, a simplified circuit diagram of an electronic circuit in accordance with another embodiment,

FIG. 4A schematically, a time progression of operating variables in accordance with an embodiment,

FIG. 4B a detailed view of the time progression from FIG. 4A,

FIG. 5 schematically, a simplified circuit diagram of an electronic circuit in accordance with another embodiment,

FIG. 6 a simplified circuit diagram of an electronic circuit in accordance with another embodiment,

FIG. 7 schematically, a simplified block diagram in accordance with another embodiment,

FIG. 8 schematically, a time progression of operating variables in accordance with another embodiment,

FIG. 9 schematically, a simplified block diagram in accordance with another embodiment,

FIG. 10 schematically, a time progression of operating variables in accordance with another embodiment,

FIG. 11 schematically, a time progression of operating variables in accordance with another embodiment,

FIG. 12 schematically, a time progression of operating variables in accordance with another embodiment, and

FIG. 13 schematically, a simplified circuit diagram of an electronic circuit in accordance with a further embodiment,

### DETAILED DESCRIPTION

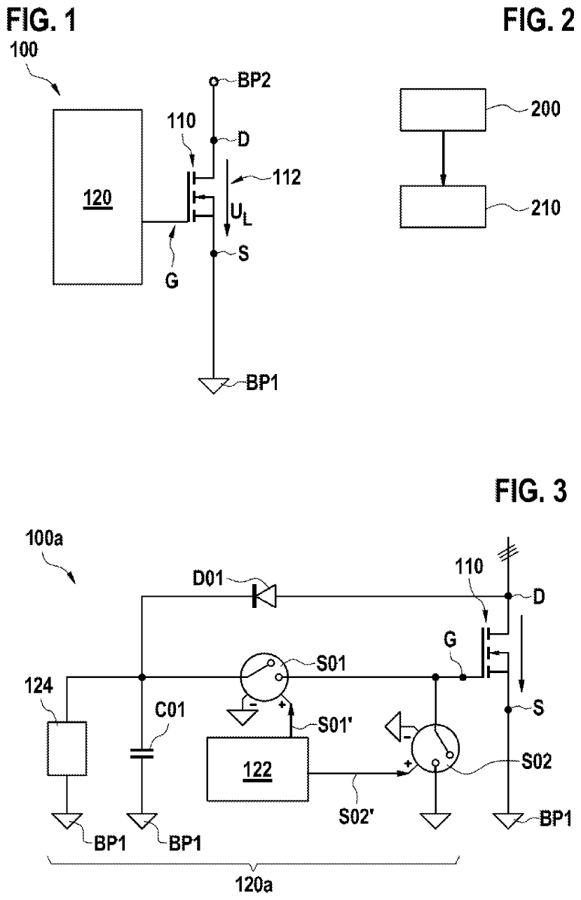

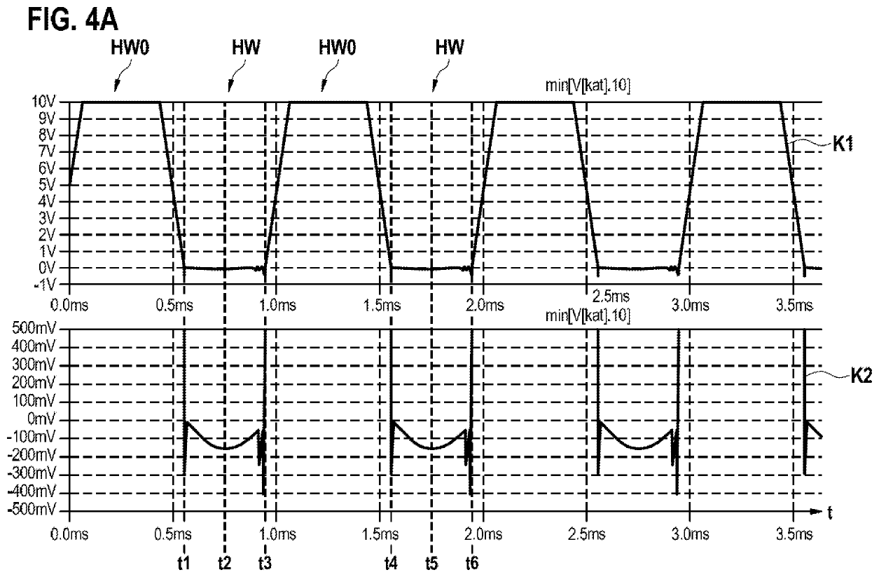

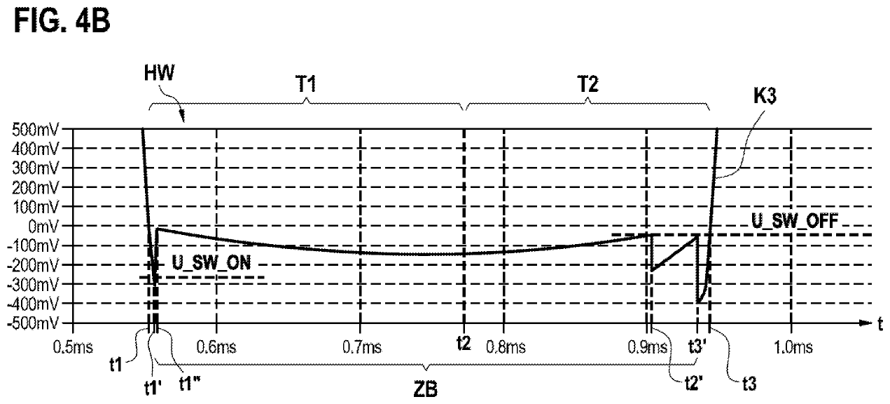

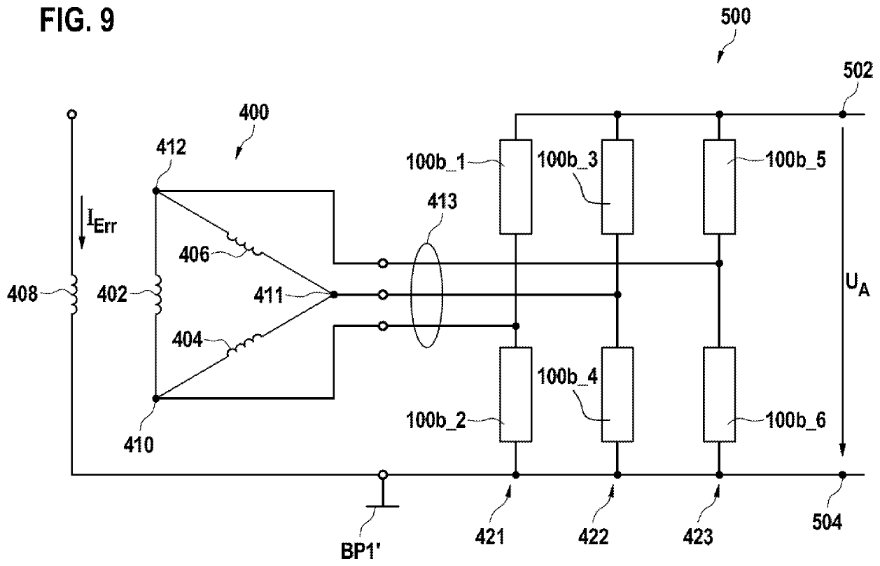

FIG. 1 schematically shows a simplified block diagram of an electronic circuit 100 in accordance with an embodiment. The circuit 100 comprises a controllable switch 110, which is presently designed as a semiconductor switch, exemplified as a MOSFET (metal-oxide semiconductor field effect transistor) of the n-type. In other embodiments, the controllable switch 110 can also be designed as a different MOSFET (e.g. p-type) or also as a bipolar transistor or IGBT or the like. The semiconductor switch 110 has a source connection (“source electrode”) S, which is connected to a first electrical reference potential BP1, for example the ground potential. Furthermore, the semiconductor switch 110 comprises a drain connection (“drain electrode”) D, which is connected to a second electrical reference potential BP2. The second reference potential BP2 can, for example, correspond to a periodic voltage, in particular a phase voltage K1 (see below, FIG. 4A) of a generator 400 (see below, FIG. 9). The semiconductor switch 110 furthermore comprises a gate connection (“gate electrode”) G, which a control device 120 assigned to the semiconductor switch 110 can affect in order to control the operation of the semiconductor switch 110. For example, the control device 120 can apply a specifiable potential to the gate connection G in order to put the load path 112 of the semiconductor switch 110 designed in the present document as a drain source path into an electrically conductive state (“low impedance”) or into a locking state (“high impedance”) or, if required, to put it into an intermediate state between the conductive and the locking state. In the conductive state, the semiconductor switch 110 or its load path 112 comprises a comparably low electrical resistance (“RDs,on”) of 0.1 ohm or less, for example, so that a load current can flow via the load path 112, and the load path 112 comprises a comparably great electrical resistance in the locking state.

In the case of preferred embodiments, the control device 120 is designed to activate the semiconductor switch 110 depending on voltage U_{L} applied to the load path 112 at a first time range of a specifiable, preferably negative half-wave of a periodic electrical voltage U_{L} that can be applied to the load path 112 of the semiconductor switch 110 and to enable a deactivation of the semiconductor switch 110 depending on the voltage U_{L} applied to the load path 112 initially at a second time range following the first time range. This provides a reliable activation of the semiconductor switch 110 at the first time range (for example, when a specifiable voltage value is fallen short of on the load path 112 at the beginning of the negative half-wave considered as an example), and simultaneously, by enabling a voltage-dependent deactivation only at the second time range following the first time range, it is avoided that an undesirable deactivation of the semiconductor switch 110 (in particular, one that occurs too early in relation to the exemplary negative half-wave considered) occurs already at the first time range, as it can otherwise occur, for example, due to fluctuations in the voltage (e.g. due to the activation of the semiconductor switch) on the load path.

FIG. 2 schematically shows a simplified flow chart of a method in accordance with an embodiment. At a first step 200, the control device 120 (FIG. 1) activates the semiconductor switch 110 at a first time range of a specifiable half-wave of a periodic electrical voltage U_{L} that can be applied to the load path 112 of the semiconductor switch 110 depending on this voltage U_{L} applied to the load path 112. At a second step 210 (FIG. 2), the control device 120 enables a deactivation of the semiconductor switch 110 depending on the voltage U_{L} applied to the load path initially at a second time range following the first time range. In other words, the activation 200, i.e. the switching on (low-impedance switching), of the semiconductor switch 110 at the first time range at step 200 is made voltage-dependent, for example, if the voltage U_{L} applied to the load path 112 falls short of a specifiable threshold value.

FIG. 4A shows, by way of example, a time progression of a periodic phase voltage of a generator in the form of a first curve K1, e.g. a motor vehicle generator, which, in the sense of the above second reference potential BP2, which was already described with reference to FIG. 1, can be applied to the drain connection D of the semiconductor switch 110. From FIG. 4A, it is evident that positive half-waves HW0 of the phase voltage assume voltage values between 0 volts (V) and about 10V as an example. Negative half-waves HW cannot be formed with a comparable amount of amplitude because the semiconductor switch 110 is switched on during the corresponding periods HW by the control device 120 (i.e. low impedance), whereby it can advantageously be used as an active rectifier diode with respect to the phase voltage of the generator. Accordingly, the first curve K1 in the respective periods corresponding to a negative half-wave HW has voltage values at the range of 0V and about −400 mV (millivolt); also compare the second curve K2, which is assigned the same scaling on the time axis t as of the first curve K1, but a different scaling of the vertical axis corresponding to the phase voltage in FIG. 4A.

FIG. 4B schematically shows a detailed view of the time progression from FIG. 4A in the form of curve K3, wherein the time range ZB shown in FIG. 4B essentially corresponds to a negative half-wave HW of the phase voltage of the generator. At point in time t1, the phase voltage falls short of the value 0V. In the case of other preferred embodiments, the control device 120 activates the semiconductor switch 110 if the phase voltage K3 falls short of an activation threshold U_SW_ON of approximately −200 mV for example. This is the case in the present case at the point in time t1′. At this point in time, therefore, the activation of the semiconductor switch 110 begins. The activation of the semiconductor switch 110 is completed at the further point in time t1″. As a result of the activation of the semiconductor switch 110, the differential voltage K3 breaks down, compare the progression of the curve K3 between the points in time t1′, t1″. The further time progression of the curve K3 from the point in time t1″ results from the course of a phase current corresponding to the phase voltage through the load path 112 (FIG. 1) of the semiconductor switch 110 based on its switch-on resistance (RDs,on).

As soon as the phase voltage K3 at the point in time t2′ reaches a specifiable first threshold u_SW_OFF, which can also be referred to as a deactivation threshold, in the case of other preferred embodiments, the semiconductor switch 110 can be deactivated again completely, or as an option, also partially. In the present case, at point in time t2′, a partial deactivation of the semiconductor switch 110 by appropriate control of its gate electrode G by means of the control device 120 takes place. By means of the partial deactivation, the resistance of the load path 112 of the semiconductor switch increases, and the phase voltage K3 decreases again at the point in time t2′ correspondingly in order to then increase further in accordance with its periodic behavior until, at the point in time t3′, the specifiable first threshold U_SW_OFF is again reached, for which the semiconductor switch 110 is now completely deactivated and its load path 112 is therefore switched to high impedance. At the point in time t3, a zero pass of the phase voltage K3 takes place towards positive voltage values and thereby, the next positive half-wave HW0 begins. As an alternative to the above-described process of initially partially deactivating the semiconductor switch 110, a complete deactivation of the semiconductor switch 110 can also take place at the point in time t2′, meaning upon first reaching the specifiable first threshold value U_SW_OFF. However, in the (initially partial) deactivation scenario described above with reference to FIG. 4B, a greater efficiency is given because the period t2′ to t3′ can still be used to guide the phase current (optimization of power loss efficiency).

After the point in time t3, a positive half-wave HW0 (FIG. 4A) follows, and thereafter, the above-described sequence from the point in time t4 to the point in time t6 can be repeated analogously to the time range t2 to t3 (FIG. 4B), wherein the point in time t5, in turn, advantageously characterizes a transition from a first time range of the negative half-wave to the second time range of the negative half-wave.

As already indicated above, the control device 120 (FIG. 1) in preferred embodiments is designed to activate the semiconductor switch 110 at a first time range T1 (FIG. 4B) of the considered (presently negative) half-wave HW of the periodic electrical voltage K3 (FIG. 4B) that can be applied to the load path 112 of the semiconductor switch 110 (FIG. 1) depending on the voltage K3, U_{L} applied to the load path 112 (for example, if the activation threshold U_SW_ON falls short of the activation threshold) and to enable a deactivation of the semiconductor switch 110 depending on the voltage K3, U_{L} applied to the load path 112 only at a second time range T2 following the first time range T1. This provides a reliable activation of the semiconductor switch 110 (present at the point in time t1′), and simultaneously, by enabling the voltage-dependent deactivation initially at the second time range T2 following the first time range T1, it is avoided that an undesirable deactivation of the semiconductor switch 110 (in particular one that is too early in relation to the considered half-wave HW) takes place already at the first time range T1, as it can occur, for example, due to fluctuations in the voltage (e.g. due to the activation of the semiconductor switch) on the load path. As can be evident from FIG. 4B, the phase voltage K3 would namely exceed the specifiable first threshold U_SW_OFF between the point in time t1′ and the point in time t1″, which would lead to an undesirable early deactivation of the semiconductor switch 110. Therefore, in accordance with the principle according to the embodiments, a voltage-dependent deactivation of the semiconductor switch 110 (compare the specifiable first threshold U_SW_OFF) would advantageously only be enabled, meaning allowed, at the second time range T2

Thus, in particularly preferred embodiments, a voltage-controlled activation of the semiconductor switch 110 at the point in time t1′ is possible, which simultaneously characterizes the beginning of the first time range T1 (alternatively, the zero crossing of the phase voltage K3 to negative voltage values all the way to the point in time t1 characterizes the beginning of the first time range T1). Next, a time-controlled operation is carried out for the rest of the first time range T1, up to the point in time t2, which characterizes a transition to the second time range T2. At the first time range T1, with the exception of activation 200 (FIG. 2) at the point in time t1′ (FIG. 4B), namely no (further) voltage-dependent control of the semiconductor switch 110 is permitted or enabled. An enabling of a voltage-dependent control of the semiconductor switch 110 rather takes place initially upon the reaching of the second time range T2, meaning with or after the point in time t2, so that the voltage-dependent complete or, initially, partial deactivation already described above can take place as of the point in time t2′.

In other preferred embodiments, it is provided that the control device 120 (FIG. 1) is designed to determine a first variable that characterizes a duration ZB (FIG. 4B) of the specifiable half-wave HW, and to determine, depending on the first variable, the first point in time t2 that characterizes a transition from the first time range T1 to the second time range T2. In other preferred embodiments, the first point in time t2 can be chosen, for example, so that it corresponds to about one half of the duration of the specifiable half-wave HW.

In other preferred embodiments, it is provided that the control device 120 (FIG. 1) is designed to control an operation of the semiconductor switch 110 depending on the voltage K3, U_{L} applied to the load path 112 at the second time range T2 (FIG. 4B).

In other preferred embodiments, it is provided that the control device 120 is designed to determine whether the voltage applied to the load path 112 exceeds a specifiable first threshold value U_SW_OFF, which makes a voltage-controlled deactivation of the semiconductor switch 110 possible as has already been described above.

In other preferred embodiments, it is provided that the control device 120 is designed to deactivate the semiconductor switch 110 at least partially if the voltage K3, U_{L} applied to the load path 112 exceeds the specifiable first threshold. This corresponds to the operating scenario described above with reference to FIG. 4B. FIG. 3 schematically shows a simplified circuit diagram of an electronic circuit 100a in accordance with another further embodiment. A control logic 122, which is for example part of a control device 120a for the semiconductor switch 110, provides control signals S01′, S02′, which act on the switches S01, S02, by means of which the gate electrode G of the semiconductor switch 110 to corresponding reference potentials can be recharged, whereby the semiconductor switch 110 can be activated or deactivated or partially deactivated. The functionality of the control device 120a can be, for example, comparable to functionality of the above control device 120 described with reference to FIG. 1.

Optionally, in the case of other preferred embodiments, the control device 120a can comprise a diode D01 and a capacitor C01, which are connected in series with respect to the drain connection D and the first reference potential BP1 as is evident from FIG. 3. This allows the capacitor C01 to be charged if there is a positive potential compared to the first reference potential BP1 applied to the drain connection D, for example, during a positive half-wave HW0 (FIG. 4A) of a phase voltage K1, K2, K3 applied to the drain connection D. In other words, the capacitor C01 can be charged during a positive half-wave HW0 of the phase voltage. The working electric charge stored in the capacitor C01 can then advantageously be transferred during a negative half-wave HW0 following the positive half-wave HW of the phase voltage applied to the drain connection D subject to the appropriate control of the switch S01 into the gate electrode G of the semiconductor switch 110 to activate it (for example voltage controlled, compare point in time t1′ in accordance with FIG. 4B). By means of this, an external electrical power supply for the control system of the gate electrode G can be advantageously done without.

Being furthermore optional, the control device 120a in other preferred embodiments can have a voltage stabilization circuit 124 (e.g. zener diode) which stabilizes the charging voltage of the capacitor C01.

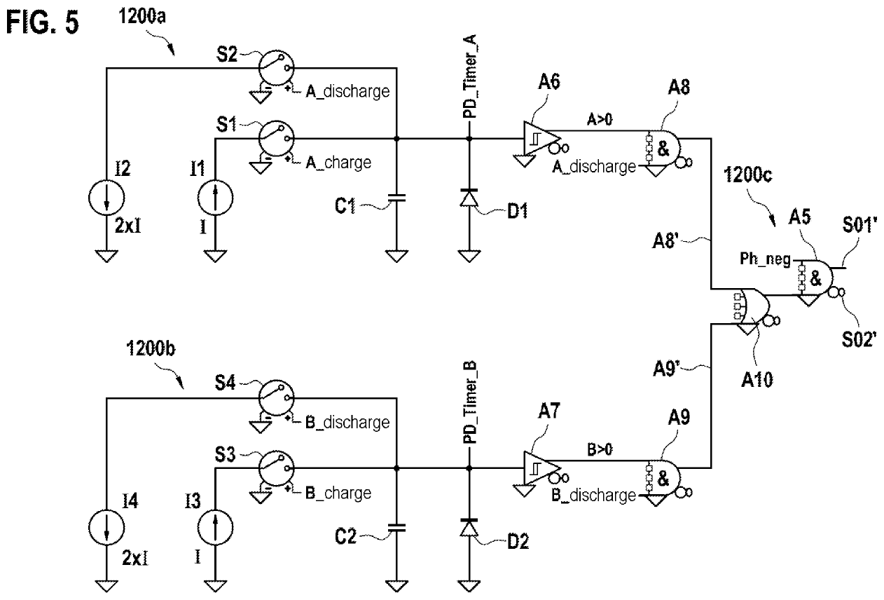

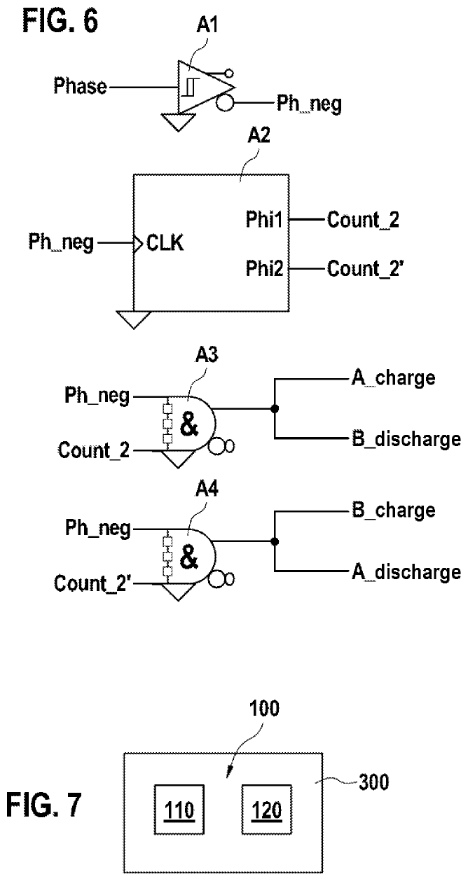

FIG. 5 schematically shows a simplified circuit diagram of an electronic circuit in accordance with a further embodiment. The circuit shown in FIG. 5 comprises a first timer circuit (timer) 1200a, a second timer circuit 1200b, as well as a linking logic 1200c, which provides the control signals S01′, S02′ for the control system of the semiconductor switch 110 in a particularly efficient manner in accordance with FIG. 3. The components 1200a, 1200b, 1200c described above with reference to FIG. 5 or their functionality can be advantageously provided in the control logic 122 in other preferred embodiments in accordance with FIG. 3. The electrical supply of the control logic 122 can also advantageously take place from the capacitor C01 so that a separate electrical power supply device is crucial for operating the control logic. This also applies to further embodiments with circuit components described further below with reference to FIG. 6.

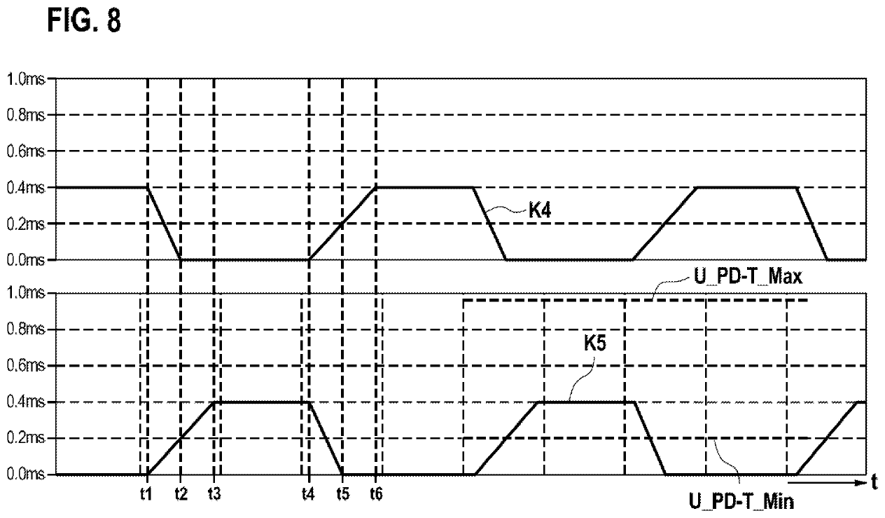

The first timer circuit 1200a in accordance with FIG. 5 comprises a first power source I1, via which the capacitor C1 can be charged under control by means of the switch S1, and a second power source I2, via which the capacitor C1 can be discharged under control by means of the second switch S2. Preferably, both power sources I1, I2 are each formed as a constant-current power supply, wherein the amount of the current provided by the second power source I2 is twice as great as the amount of the current provided by the first power source E1 (the current direction is opposite to each other in order to allow the above-described charging or discharging of the capacitor C1). For the voltage at the capacitor C1, the time progression indicated in FIG. 8 by means of the curve K4 results as an example. Obviously, an end of the discharge process of the capacitor C1 corresponds to the specifiable point in time t2, which characterizes a transition from the first time range T1 (FIG. 4B) to the second time range T2, while a charging process extends across the entire duration ZB of a negative half-wave HW, cf. period t4 to t6 in FIG. 8. In the case of preferred embodiments, the charging of the capacitor C1 (FIG. 5) corresponds with a “learning” of the duration ZB, cf. the period t4 to t6 in FIG. 8, which can fluctuate accordingly due to a variable rotational speed of a generator that provides the phase voltage. The discharge of the capacitor C1 in relation to the charging at double speed (via double the amount of charging current, cf. the power source I2) thus causes the determination of the specifiable point in time t2 or t5 (FIG. 8) in the middle of the duration ZB of the half-wave HW (FIG. 4B).

By means of a Schmitt trigger A6 (FIG. 5) and a downstream AND element A8, depending on the voltage at capacitor C1 and the signal A_discharge, a logic signal A8′ is generated, which can be supplied to the linking logic 1200c. The switches S1, S2 of the first timer circuit 1200a are hereby controlled depending on the signals A_charge, A_discharge as an example, which, as described below as an example, and, in turn, can be determined in a very energy efficient manner by means of the circuit in accordance with FIG. 6.

FIG. 6 shows a Schmitt trigger A1, to which a signal phase representing the phase voltage (cf., for example, reference sign K3 from FIG. 4B) is supplied on the input side and which thereby generates a binary signal Ph_neg, which indicates when there is a negative half-wave HW (FIG. 4B). In other words, the signal Ph_neg, for example, logically comprises a value one if there is a negative half-wave HW of the phase voltage. The signal phase can be derived in the case of a low-side (LS) path, for example, from the drain connection D (FIG. 3) of the semiconductor switch 110, in the case of a high-side (HS) path from the source port S (FIG. 3).

FIG. 6 also shows a meter module A2, in particular a change meter, which can be implemented, for example, by means of a flip-flop. As clock signal CLK, the signal Ph_neg is fed to the change meter A2, which forms depending on this two output signals count_2, count_2′.

Depending on the signals Ph_neg, count_2, count_2′, by means of two AND elements A3, A4, the signals A_charge, A_discharge, B_charge, B_discharge are formed, wherein the two signals A_charge, A_discharge can be used for the operation of the first timer circuit 1200a as described above.

The second timer circuit 1200b has a structure comparable to the first timer circuit 1200a and serves to generate the logic signal A9′, which, together with the other signals A8′, Ph_neg, is transformed into the control signals S01′, S02′ that are complementary to one another by means of logic elements A10, A5 for the control of the gate electrode G of the semiconductor switch 110.

Thereby, in preferred embodiments, charging of the capacitor C2 corresponds to the second timer circuit 1200b (FIG. 5) with a “learning” of the duration ZB at the period t1 to t3 in FIG. 8 and discharging of the capacitor C2 with reference to charging (current source I3) at double the speed (by twice the charge current, cf. the power source I4) thereby causes the determination of the specifiable point in time t5 or t2 (FIG. 8) in the middle of the duration ZB of the half-wave HW (FIG. 4B).

The above-described timer circuits 1200a, 1200b can also be referred to as period duration timers or PD timers, because a first PD timer learns the duration ZB of the half-wave HW during a first considered (negative) half-wave HW of the phase voltage K3 while the second PD timer is used during the same considered half-wave HW to control the semiconductor switch 110, and vice versa. In the case of other preferred embodiments, the learning time (e.g. point in time t1 to t3 or t4 to t6) and the control time (e.g. point in time t1 to t2 or t4 to t5) are not the same, but the control time is generally shorter than the learning time. This is favourable because, from period to period of phase voltage, a reduction in the period time (and thus also the duration ZB of an exemplary negative half-wave HW) can occur (for example, by a rotational speed change or current change of the generator), thereby being able to be held through a passive rectification window. In other preferred embodiments, the time ratio between learning time and driving time is typically between about 50% and about 99%. In other preferred embodiments, the learning time is determined by the time difference between the points in time t3, t1 in accordance with FIG. 4B, while the driving time is determined by means of the time difference between the points in time t2, t1. In other words, the learning time corresponds to the sum of the first time range T1 and the second time range T2 for preferred embodiments, whereas the timed driving time corresponds to the first time range T1 and, in particular, can be used for determining the point in time t2.

The principle in accordance with the present embodiments advantageously allows the use of a voltage-controlled method for deactivating the semiconductor switch 110 upon reaching the first point in time t2 (FIG. 4B). In particular, in preferred embodiments, the semiconductor switch 110 can continue to bu_SW_OFF.

By applying the principle in accordance with the embodiments with a combination of time control (first time range T1, starting with an activation of the semiconductor switch 110) and voltage control (second time range T2, deactivation of the semiconductor switch 110), it is advantageously ensured that a minimum control of the semiconductor switch 110 is guaranteed even at low phase currents and that, at high phase currents, the time window T2 of the active control is extended (in particular, extension of the maintaining of the activation of the semiconductor switch at the time range t2′ to t3′).

The exemplary implementation of the PD timer 1200a, 1200b described above with reference to FIG. 5 is particularly advantageous, since, a linear relationship between the capacitor voltage and time results in the case of charging and discharging the related capacitors C1, C2 by means of the constant-current power supplies I1, I2, I3, I4. In addition or as an alternative, in further embodiments, a charge or discharge of the capacitors C1, C2 via a resistor (not shown) can be provided, wherein a nonlinear relationship between the voltage and the time results.

In addition or as an alternative, in the case of other embodiments, a meter (not shown) with a time-discrete control system can be used over a clock generator. The above mentioned different embodiments advantageously each allow a precise determination of the first point in time t2, which characterizes a transition from the first time range T1 to the second time range T2.

Other favourable embodiments are described below. In another preferred embodiment, a plausibility is proposed. For this purpose, reference is made to the time progression of the capacitor voltages of the PD timer 1200a, 1200b (FIG. 5). Curve K4 in accordance with FIG. 8 represents a time progression of the voltage at the capacitor C1 of the first PD timer 1200a, and curve K5 represents a time progression of the voltage at the capacitor C2 of the second PD timer 1200b. According to the applicant's analyses, in a real system (e.g. generator of a motor vehicle), typically, only certain minimum and maximum time durations (or period durations of the phase voltages or a respectively corresponding duration ZB of a negative half-wave HW (FIG. 4B)) typically occur depending, for example, on a possible rotational speed range and a pole pair number of the generator.

In another preferred embodiment, a correlating minimum voltage U_PD-T_MIN (FIG. 8) is defined, as well as a correlating maximum voltage U_PD-T_MAX. Here, the minimum voltage U_PD-T_MIN correlates with a maximum rotational speed of the generator and the maximum voltage U_PD-T_MAX correlates with a minimum rotational speed of the generator since the duration ZB (FIG. 4B) of the control window decreases as rotational speed of the generator increases. The maximum value ZB is ZB=30/(n*PP), wherein PP is the pole pair number and n is the generator speed 1/min. In other preferred embodiments, it is proposed that the capacitor voltages of the capacitors C1, C2 of the PD timer 1200a, 1200b outside the voltage range between the maximum voltage U_PD-T_MAX and the minimum voltage U_PD-T_MAX are deemed to be implausible (and optionally set to zero), wherein a rectification of the phase voltage takes place, for example, purely passively after exceeding or undershooting the voltage range between the maximum voltage U_PD-T_MAX and the minimum voltage U_PD-T_MAX in a subsequent period of phase voltage, meaning by means of a parasitic diode (not shown) of the semiconductor switch 110. A corresponding logic (not shown) for this plausibility can, for example, also be provided in the control device 120.

In other preferred embodiments, this function can also advantageously be used for a measurement of a temperature (“chip temperature”) of a semiconductor substrate (“chip”) comprising the semiconductor switch 110 since a voltage drop at the parasitic diode (not shown) of the semiconductor switch 110 correlates with the chip temperature. Such measurements can be used in further preferred embodiments, for example, for the determination of a thermal connection (“R_th”) in a production cycle. For such a temperature measurement, it is preferably ensured that the active control system of the semiconductor switch 110 is switched off. This can be achieved in other preferred embodiments, for example, by specifying a control window outside the abovementioned plausibility range U_PD-T_MIN to U_PD-T_MAX.

FIG. 7 shows, schematically, a simplified block diagram in accordance with a further embodiment. Reference number 300 indicates a semiconductor substrate on which both the semiconductor switch 110 and the control device 120 of the circuit 100 are arranged. This results in a particularly small configuration. For example, the semiconductor substrate 300 with the components 110, 120 may have such a low construction volume that conventional passive rectifier diodes in a corresponding target system (e.g. active rectifier) can be replaced by the semiconductor substrate 300 with the electronic circuit 100 in accordance with the embodiments. This advantageously gives the possibility of an active rectification, which, due to the low on-resistance of the load path 112 of the semiconductor switch 110 in its activated, meaning switched on, state causes much lower ohmic losses than the operation of conventional rectifier diodes. Furthermore, the circuit 100 arranged on the semiconductor substrate 300 allows for simple construction, easy assembly, the mentioned small size, a high mechanical robustness, and comparatively low manufacturing costs.

The circuit 100, 100a in accordance with the embodiments can advantageously be provided in the form of an electric two-terminal network, the first connection of which is, for example, the drain electrode D (FIG. 1), and the second connection of which is, for example, a ground connection (source electrode S) for connection to the first reference potential BP1. With the optional provision of the capacitor C01 in accordance with FIG. 3, a safe self-sufficient operation of the circuit 100a is ensured even during negative half-waves HW of the phase voltage of the semiconductor switch 110 applied to the load path 112. Particularly preferably, the capacitance of the capacitor C01 can be chosen to be comparatively low in other embodiments, for example at the range of a capacitance of the gate electrode G of the semiconductor switch 110 or, for example, at the range of about 40% to approximately 150% of the capacitance of gate electrode G of the semiconductor switch 110. According to the applicant's analyses, this capacitance is sufficient for a safe and complete control of the semiconductor switch 110 during a (e.g. negative) half-wave HW of the phase voltage (including e.g. the operation of the circuit components according to FIG. 5, 6). For a new control system in the context of a subsequent (e.g. negative) half-wave of the phase voltage, the capacitor C01 can be charged by a corresponding positive half-wave HW0 (FIG. 4A), which follows the first half-wave HW, and so on (bootstrap principle).

In other favourable embodiments, it is also conceivable to integrate a plurality of semiconductor switches 110 and their assigned control devices 120 on the same semiconductor substrate 300; cf. FIG. 7. For example, two similar or different semiconductor switches 110, each with an assigned control device 120, can be integrated on a (same) semiconductor substrate 300, wherein the first integrated semiconductor switch 110 can form a so-called high-side switch, and wherein the second integrated semiconductor switch 110 can form a so-called low-side switch.

Further preferred embodiments refer to an active rectifier circuit 500 with at least one circuit 100, 100a in accordance with the embodiments. FIG. 9 schematically shows a simplified block diagram for this purpose.

A generator 400, for example a generator for a motor vehicle, is shown with three phase-forming phase windings 402, 404, 406, which are connected in triangular topology. The totality of all phase winding 402, 404, 406 forms, for example, a stator winding of the generator 400. An excitation winding 408, to which it is known, in itself, that an exciting current is capable of being applied IErr, is assigned to the rotor (not shown) of the generator 400. In the case of rotating the rotor and thus the excitation winding 408 relative to the stator winding of the generator 400, in the phase-forming phase windings 402, 404, 406, a corresponding phase voltage is respectively induced, which can be supplied via the circuit nodes 410, 411, 412 of the active rectifier circuit 500; also compare reference number 413.

The active rectifier circuit 500 comprises a first series circuit 421 consisting of two electronic circuits 100b_1, 100b_2, each of which, for example, have the configuration 100 and 100a in accordance with FIGS. 1 to 8, and the rectifiers described as active each work like in the above with reference to FIGS. 1 to 8. The first series circuit 421 is assigned to a first phase of the generator 400; also compare the circuit node 410. A second series circuit 422 from comparable two-pole networks 100b_3, 100b_4 (both similar or identical to the configuration 100 or 100a) is assigned in a comparable manner to the second phase of the generator 400; also compare the circuit node 411. A third series circuit 423 from comparable two-pole networks 100b_5, 100b_6 (both similar or identical to the configuration 100 or 100a) is assigned in a comparable way to the third phase of the generator 400. Accordingly, an output voltage UA actively rectified by the rectifier circuit 500 is applied to the terminals 502, 504.

In other particularly preferred embodiments, the circuit 100, 100a, 100b 100b_6 in accordance with the embodiments can advantageously be used for the provision of an active rectifier circuit 500 instead of conventional passive diodes, for example, press-in diodes. Particularly advantageously, due to embodiments described in the above with reference to FIGS. 1 to 8, no separate control logic is required because, in accordance with the embodiments, a separate control device 120 is assigned to each circuit 100, 100a, which can be arranged in a particularly favourable manner on the same substrate like the assigned semiconductor switch 110 of the circuit 100, 100a.

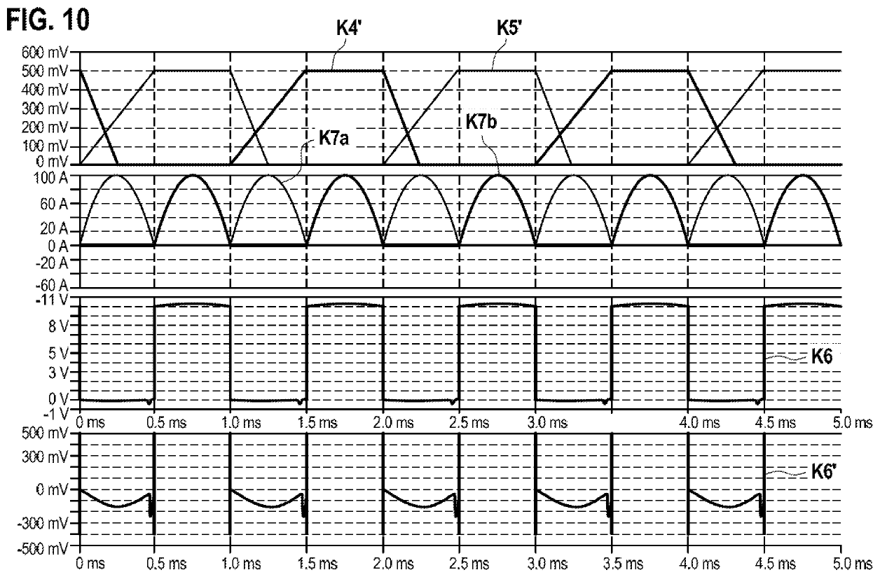

FIG. 10 schematically shows a time progression of operating variables in accordance with a further embodiment, where the two semiconductor switches 110 are connected in accordance with the embodiments, for example, for the rectification of a phase of an alternating voltage, comparable to the series circuit 100b_1, 100b_2 in accordance with FIG. 9. Similar to FIG. 8, reference number K4, K5, FIG. 10 shows a time progression of voltages K4′, K5′ of the capacitors C1, C2 of the PD timer 1200a, 1200b from FIG. 5. Curve K6 indicates a time progression of a voltage on a load path 112 (FIG. 1) of a considered semiconductor switch 110 (i.e. the drain source voltage UDS in the case of a MOSFET 110 for example), and the curve K6′ corresponds to the curve K6, shown with another scaling of the vertical axis. The curves K7a, K7b indicate the essentially pulse-shaped “diode currents” through the load paths of the considered semiconductor switches. The time progression shown in FIG. 10 corresponds to essentially proper operation.

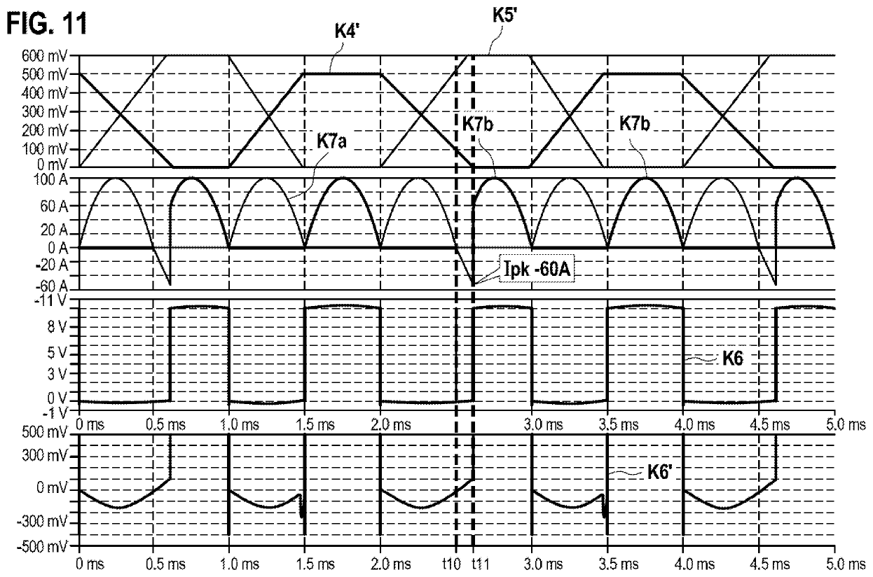

On the other hand, FIG. 11 shows a scenario comparable to FIG. 10, but with a too long control over the PD timer-zero passage of the signal to be rectified, compare point in time t10 and curve K4′. The shutdown of the considered semiconductor switch takes place only after the expiry of the PD timer, namely at the point in time t11>t10, and a current through the load path of the relevant semiconductor switch reaches Ipk values of up to about −60 A in inverse direction. This corresponds to an error, the current flows through the load path with regard to the desired rectification “in the wrong direction”. Such a long control can result, for example, due to an error in the control device 120 (FIG. 1).

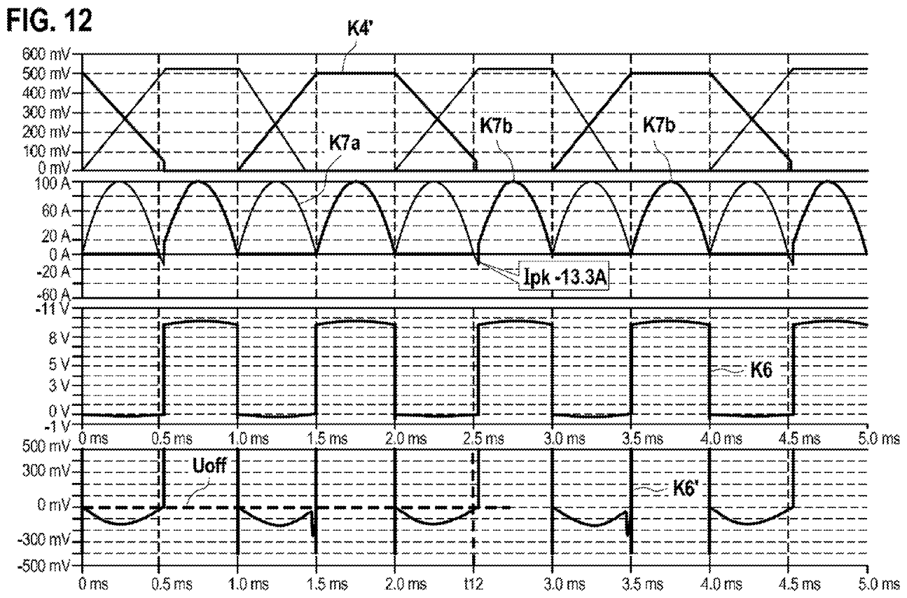

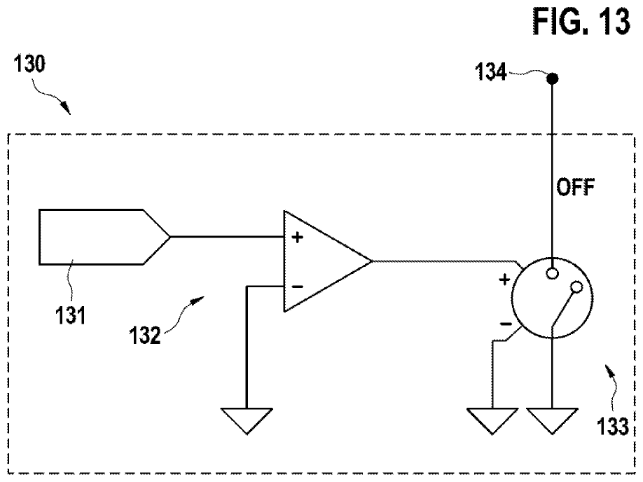

Therefore, in other preferred embodiments, a safety shutdown device 130 (FIG. 13) is provided, which is designed to deactivate the semiconductor switch 110 (FIG. 1) if the voltage applied to the load path 112 is positive and exceeds a specifiable second threshold. This can safely avoid the event of an error described above with reference to FIG. 12. Being particularly preferred, the safety shutdown device 130 is designed to deactivate the semiconductor switch 110 independently of an instantaneous operating state (e.g. first time range T1, second time range T2; cf. FIG. 4B) of the control device 120 (FIG. 1). This means that in the event of an error, the semiconductor switch 110 can be safely deactivated in any operating state of the control device 120. Particularly preferably, the control system of the semiconductor switch 110 through the safety shutdown device 130 has a higher priority than the control system of the semiconductor switch 110 through the control device 120. This ensures that, independently of a current operating state or fault state of the control device 120, a safe deactivation of the semiconductor switch 110 in undesirable operating states can take place (e.g. positive voltage on the load path 112 greater than the second threshold value).

The safety shutdown device 130, cf. FIG. 13, comprises, for example, a comparator 132, to which the present voltage 131 on the load path 112 (FIG. 1) can be supplied, and which compares this voltage 131 to the specifiable second threshold. The specifiable second threshold has, for example, values between about 10 mV and about 25 mV, preferably about 18 mV to about 22 mV, so that the safety shutdown device 130 can respond early on in the event of a failure. An output of the comparator 132 acts on the switch 133, which can output a corresponding control signal OFF for deactivating the semiconductor switch 110 to a connection 134 of the safety shutdown device 130. The connection 134 is preferably connected directly to the control connection or gate connection (“gate electrode”) G of the semiconductor switch 110 (e.g. in addition to the connection of the control device 120 to the gate electrode G), whereby the control signal OFF can act directly on the gate electrode G and can deactivate the semiconductor switch 110 (high-impedance switch). Particularly preferably, the safety shutdown device 130 is designed in such a way that it can safely deactivate the semiconductor switch 110 by means of the OFF control signal even if the control device 120 controls the gate electrode Gin such a way that the semiconductor switch 110 is not deactivated due to a fault. This can be achieved, for example, by the OFF control signal being able to charge the gate electrode G of the semiconductor switch 110 with a sufficiently large current strength to an electrical potential, which corresponds to a deactivation (high-impedance switching) of the semiconductor switch 110, independently of a control signal provided, if applicable, by the control device 120 for the gate electrode G, as it can be produced by the switch S01, S02 (FIG. 3) for example.

FIG. 12 schematically shows a scenario comparable to FIG. 11, where, using the safety shutdown device 130 described above with reference to FIG. 13, a safety shutdown of the semiconductor switch concerned takes place in the event of failure, whereby an undesirable increase of the current via the load path of the relevant semiconductor switch can be limited in inverse direction. In turn, the considered semiconductor switch is controlled for too long due to error via the PD timer K4″; in contrast to FIG. 11, however, in the scenario in accordance with FIG. 12, a forced shutdown of the semiconductor switch 110 occurs at the point in time t12 when reaching the specifiable second threshold Uoff, which corresponds e.g. to a comparatively small positive voltage of about +20 mV. Thus, the current in the inverse direction K7a by the load path 112 (FIG. 1) is limited to a peak value Ipk of about −13.3 A, so, with regard to the amount, significantly less than in the scenario in accordance with FIG. 11.

Particularly advantageously, the safety shutdown device 130 together with the semiconductor switch 110 or at least one semiconductor switch 110 and the control device 120 can also be arranged on the same semiconductor substrate.

Other preferred embodiments refer to a use of the method in accordance with the embodiments for operating an active rectifier circuit 500, wherein the active rectifier circuit 500 comprises, in particular, at least one circuit 100, 100a, 100b_1, . . . , 100b_6 in accordance with the embodiments.

The principle in accordance with the embodiments can be used in a particularly favourable manner for providing active rectifier circuits in the form of a two-terminal network 100, 100a or of multiphase rectifier circuits 500. Particularly advantageously, thereby, active rectifier circuits for generators, in particular alternators (single- or multiphase), can be provided by motor vehicles for example. The principle in accordance with the embodiments can also be used for the reciprocity of electrical voltages of any alternating current sources such as transformers and the like. Here, too, there are similar advantages.

The principle in accordance with the embodiments can also be advantageously used as an active two-terminal network 100, 100a for all circuits, in particular power electronics circuits, which require a freewheeling diode, for example for pulse inverters, which are fitted with IGBTs (bipolar transistor with insulated gate electrode). Here, the electronic circuit 100, 100a can therefore be used as an active diode in the sense of a freewheeling diode for IGBT(s).

1. An electronic circuit (100; 100a) having a controllable switch (110) and a control device (120) for controlling the controllable switch (110), wherein the control device (120) is configured to activate (200) the controllable switch (110) depending on the voltage (U_{L}; K1, K2, K3) applied to a load path (112) at a first time range (T1) of a specifiable half-wave (HW) of a periodic electrical voltage (U_{L}; K1, K2, K3) that is applied to a load path (112) of the semiconductor switch (110) and to enable (210) a deactivation of the controllable switch (110) depending on the voltage (U_{L}; K1, K2, K3) applied to the load path (112) initially at a second time range (T2) following the first time range (T1).

2. The electronic circuit (100; 100a) according to claim 1, wherein the controllable switch (110) is a semiconductor switch.

3. The electronic circuit (100; 100a) according to claim 1, wherein the specifiable half-wave (HW) is a negative half-wave.

4. The electronic circuit (100; 100a) according to claim 1, wherein the control device (120) is configured to determine a first variable that characterizes a duration (ZB) of the specifiable half-wave (HW), and to determine, depending on the first variable, a first point in time (t2) that characterizes a transition from the first time range (T1) to the second time range (T2).

5. The electronic circuit (100; 100a) according to claim 1, wherein the control device (120) is configured to control an operation of the controllable switch (110) depending on the voltage (U_{L}; K1, K2, K3) applied to the load path (112) at the second time range (T2).

6. The electronic circuit (100; 100a) according to claim 1, wherein the control device (120) is configured to determine whether the voltage (U_{L}; K1, K2, K3) applied to the load path (112) exceeds a specifiable first threshold (U_SW_OFF).

7. The electronic circuit (100; 100a) according to claim 6, wherein the control device (120) is configured to deactivate the controllable switch (110) at least partially if the voltage (U_{L}; K1, K2, K3) applied to the load path (112) exceeds the specifiable first threshold (U_SW_OFF).

8. The electronic circuit (100; 100a) according to claim 1, wherein the controllable switch (110) and the control device (120) are arranged on the same semiconductor substrate (300).

9. The electronic circuit (100; 100a) according to claim 1, wherein a safety shutdown device (130) is provided, which is configured to deactivate the controllable switch (110) if the voltage applied to the load path (112) is positive and exceeds a specifiable second threshold (U_{off}).

10. The electronic circuit (100; 100a) according to claim 9, wherein, the safety shutdown device (130) is configured to deactivate the controllable switch (110) independently of a momentary operating state of the control device (120).

11. An active rectifier circuit (500) with at least one circuit (100; 100a) according to claim 1.

12. The active rectifier circuit (500) according to claim 11, wherein the control device (120) activates (200) the controllable switch (110) depending on the voltage (U_{L}; K1, K2, K3) that is applied to a load path (112) of the controllable switch (110) at a first time range (T1) of a specifiable, half-wave (HW) of a periodic electrical voltage (U_{L}; K1, K2, K3) that can be applied to a load path (112) and enables (210) a deactivation of the controllable switch (110) depending on the voltage (U_{L}; K1, K2, K3) applied to the load path (112) initially at a second time range (T2) following the first time range (T1).

13. A method for operating an electronic circuit (100; 100a) having a controllable switch (110), and a control device (120) for controlling the controllable switch (110), wherein the control device (120) activates (200) the controllable switch (110) depending on the voltage (U_{L}; K1, K2, K3) that is applied to a load path (112) of the controllable switch (110) at a first time range (T1) of a specifiable, half-wave (HW) of a periodic electrical voltage (U_{L}; K1, K2, K3) that can be applied to a load path (112) and enables (210) a deactivation of the controllable switch (110) depending on the voltage (U_{L}; K1, K2, K3) applied to the load path (112) initially at a second time range (T2) following the first time range (T1).

14. The method according to claim 13, wherein the controllable switch (110) is a semiconductor switch.

15. The method according to claim 13, wherein the specifiable half-wave (HW) is a negative half-wave.

16. The method according to claim 13, wherein the control device (120) determines a first variable that characterizes a duration (ZB) of the specifiable half-wave (HW), and determines, depending on the first variable, a first point in time (t2) that characterizes a transition from the first time range (T1) to the second time range (T2).

17. The method according to claim 13, wherein the control device (120) controls an operation of the controllable switch (110) depending on the voltage (U_{L}; K1, K2, K3) applied to the load path (112) at the second time range (T2).

18. The method according to claim 13, wherein the control device (120) determines, whether the voltage (U_{L}; K1, K2, K3) applied to the load path (112) exceeds a specifiable first threshold (U_SW_OFF).

19. The method according to claim 18, wherein the control device (120) determines, whether the voltage (U_{L}; K1, K2, K3) applied to the load path (112) exceeds the specifiable first threshold (U_SW_OFF) at the second time range (T2).

20. The method according to claim 19, wherein the control device (120) deactivates the controllable switch (110) at least partially if the voltage (U_{L}; K1, K2, K3) applied to the load path (112) exceeds the specifiable first threshold (U_SW_OFF).
